(19) United States
(12) Patent Application Publication
(10) Pub. No.: US 2004/0268242 A1
(43) Pub. Date: Dec. 30, 2004

(54) Object persister

(75) Inventors: Andrew J. Layman, Bellevue, WA (US); Gopal Krishna R. Kakivaya, Sammamish, WA (US); Satish R. Thatte, Redmond, WA (US)

Correspondence Address: LEE & HAYES PLLC, 421 W RIVERSIDE AVENUE SUITE 500, SPOKANE, WA, 99201

(73) Assignee: Microsoft Corporation, Redmond, WA

(21) Appl. No.: 10/893,787

(22) Filed: Jul. 16, 2004

Related U.S. Application Data
(63) Continuation of application No. 09/635,830, filed on Aug. 9, 2000.

(51) Int. Cl. G06F 7/00

(52) U.S. Cl. 715/513

(57) ABSTRACT

Herein is described an implementation of an object persister, which serializes an object to preserve the object's data structure and its current data. The serialized object is encoded using XML and inserted within a message. That message is transmitted to an entity over a network. Such a transmission is performed using standard Internet protocols, such as HTML. Upon receiving the serialized object, the receiving entity deserializes the object to use it. Rather than include copies of referenced objects within the serialized object, the object persister includes references to those objects. This avoids redundant inclusion of the same object and potentially infinite inclusion of the object itself that is being serialized.

### RELATED APPLICATIONS

This application is a continuation of and claims priority to U.S. patent application Ser. No. 09/635,830, filed Aug. 9, 2000, the disclosure of which is incorporated by reference herein.

### TECHNICAL FIELD

This invention relates the preservation of objects for later recovery and use.

### BACKGROUND

Storing an object for later use by an application is called “object persistence.” In addition, encoding an object for transmission over a distributed network is called object persistence. Object persistence is also known as “serializing an object.” An “object” is the core concept of an “object-oriented paradigm.

Object-Oriented Paradigm

A large segment of the computing realm operates under the object-oriented paradigm. This is sometime called “object technology” or “object-oriented programming.” In general, an object is understood to encapsulate data and procedures (i.e., methods).

Object-oriented programming is a type of programming in which programmers define not only the data type of a data structure, but also the types of operations (i.e., procedures, functions, or methods) that can be applied to the data structure. In this way, the data structure becomes an object that includes both data and functions. In addition, programmers can create relationships between one object and another. For example, objects can inherit characteristics from other objects.

One of the principal advantages of object-oriented programming techniques over procedural programming techniques is that they enable programmers to create modules that do not need to be changed when a new type of object is added. A programmer can simply create a new object that inherits many of its features from existing objects. This makes object-oriented programs easier to modify.

To perform object-oriented programming, one needs an object-oriented programming language (OOPL). “Java,” “C++,” and “Smalltalk” are three of the more popular languages, and there are object-oriented versions of Pascal.

The object-oriented paradigm allows for the fast development of applications to solve real problems. Using this paradigm, applications can interact with other applications (or the operating system) on the same computer. Such an interaction may involve sharing data or requesting execution of a task by another application. For example, the Component Object Model (COM), by the Microsoft Corporation, enables programmers to develop objects that can be accessed by any COM-compliant application on the same computer.

The object-oriented paradigm also allows applications to interact with applications on different computers. This is often called “distributed computing.”

Generally, distributed computing utilizes different components and objects comprising an application that are located on different computers coupled to a network. So, for example, a word processing application might consist of an editor component on one computer, a spell-checker object on a second computer, and a thesaurus on a third computer. In some distributed computing systems, each of the three computers could even be running a different operating system.

One of the requirements of distributed computing is a set of standards that specify how objects communicate with one another. There are currently two chief distributed computing standards: CORBA (Common Object Request Broker Architecture) and DCOM (Distributed Component Object Model).

For example, programmers may use DCOM (by the Microsoft Corporation) to develop objects that can be accessed by any DCOM-compliant application on a different computer. DCOM is an extension of COM to support objects distributed across a network.

Object Serialization

Serialization is the process of saving and restoring objects. More precisely, serialization is the process of saving and restoring the current data and the data structures of objects. The information is extracted from objects so that it is not lost or destroyed. In other words, the transitory status of objects is fixed (often in a file or a database) for the purpose of storage or communications. This process is also called “object persistence.”

If an application using an object is closed, then the object's data and its data structures must be preserved so that the object may be restored into its current state when the program is invoked again. For example, it is often necessary to temporarily store an object so that another application may access it. In another example, sending an object to another computer in a distributed computing environment requires the object be stored, transmitted, received, and recovered. In each of these examples, objects are stored and restored.

When serializing an object, the focus is not so much on how to store an object's data in non-volatile memory (such as a hard drive), but rather on how the in-memory data structure of an object differs from how the data appears once it has been extracted from the object. In memory, the data is located at arbitrary addresses, which are conceptually defined as data structures including data, arrays, objects, methods, and the like. However, these data structures cannot be stored directly.

To store a data structure, it must be broken down into its component parts, which includes simple data types like integers, strings, floating point numbers, etc. In addition, the hierarchical arrangement within each data structure must be stored and maintained. Furthermore, the hierarchical arrangement of data structures themselves must be stored and maintained.

The serialized data of an object may be thought of as a “dehydrated object” where all of the water (object functions in this metaphor) has been squeezed out of the object. This leaves only dry potato flakes (the data). Later, a hungry person wishes to have mashed potatoes (the object with the data), the potato flakes may be rehydrated. To “add water” to a dehydrated object, an empty object is created and the stored data is inserted therein.

Serialization of an object is an effective and important step in exchanging the object between computers. These types of object exchanges are important to a distributed computing environment where computers actively distribute objects across a network. Those of ordinary skill in the art are familiar with object serialization.

Serialization Issues

Separating Data Items: When serializing an object, data items must be separated from each other when they are stored. Otherwise, they will not be properly identified later when reading the data back into a new object during deserialization. Therefore, a serialization scheme must specify how data items are separated from each other.

Preserving Hierarchical Structure: Unless the hierarchical structure of the data is preserved during the serialization process, it cannot be recreated during a deserialization. Each data structure is potentially different from each other.

Therefore, a serialization scheme must have a general data format suiting the needs of all potential data structures of an object. Typically, such a scheme accomplishes this by having the capability to delimit arbitrary nested data, that is, truly hierarchical data structures.

Preserving Object Relationships: Often objects include references to other is objects. When in memory, this reference is often a pointer in memory to the other objects. When serializing an object with a reference to another object, the serialized object includes the entire object like its does for a data structure.

However, if there are multiple references to the same object, then there are redundant inclusions of the same object. Furthermore, if the reference within an object is to itself (directly or indirectly), then the serialization process may fail because it is circularly and potentially infinitely storing object data.

Extensible Markup Language (XML)

SGML (Standard Generalized Markup Language) is a generic text formatting language that is widely used for large databases and multiple media projects. It is particularly well suited for works involving intensive cross-referencing and indexing.

HTML (HyperText Markup Language) is a specific implementation of a subset of SGML and is nearly universally used throughout the global as the foundation for the World Wide Web (“Web). HTML uses tags to mark elements, such as text and graphics, in a document to indicate how Web browsers should display these elements to the user. HTML tags also indicate how the Web browsers should respond to user actions such as activation of a link by means of a key press or mouse click.

XML (eXtensible Markup Language) is a specific implementation of a condensed form of SGML. XML lets Web developers and designers create customized tags that offer greater flexibility in organizing and presenting information than is possible with the HTML document coding system.

In HTML, both the tag semantics and the tag set are fixed. XML specifies neither semantics nor a tag set. In fact, XML is really a meta-language for describing markup languages. In other words, XML provides a facility to define tags and the structural relationships between them. Since there's no predefined tag set, there are no preconceived semantics. All of the semantics of an XML document will be defined either by the applications that process them or by stylesheets.

As the Internet becomes a serious business tool, HTML's limitations are becoming more apparent. For example, HTML can be used to exchange data, but it is not capable of exchanging objects. To be more precise, HTML cannot be used to exchange serialized objects.

XML does not have defined protocol for exchanging serialized objects between computers within a distributed computing environment.

### SUMMARY

The object persister serializes an object to preserve the object's data structure and its current data. The serialized object is encoded using XML and inserted within a message. That message is transmitted to an entity over a network. Such a transmission is performed using standard Internet protocols, such as HTML. Upon receiving the serialized object, the receiving entity deserializes the object to use it.

Rather than include copies of referenced objects within the serialized object, the object persister includes references to those objects. This avoids redundant inclusion of the same object and potentially infinite inclusion of the object itself that is being serialized.

### BRIEF DESCRIPTION OF THE DRAWINGS

FIG. 1 is a schematic illustration of an exemplary computer network (such as the Internet) that includes two computer entities.

FIG. 2a is a textual illustration of a typical data structure of an object as represented in pseudocode.

FIG. 2b is a textual illustration of a serialized object generated by an implementation of the exemplary object persister, where the typical data structure shown in FIG. 2a is the base object that was serialized.

FIG. 3 is flowchart showing a process implementing the exemplary object persister.

FIG. 4 is an example of a computer capable of implementing the exemplary object persister.

### DETAILED DESCRIPTION

The following description sets forth a specific embodiment of the object persister that incorporates elements recited in the appended claims. This embodiment is described with specificity in order to meet statutory written description, enablement, and best-mode requirements. However, the description itself is not intended to limit the scope of this patent. Rather, the inventors have contemplated that the claimed object persister might also be embodied in other ways, in conjunction with other present or future technologies.

Computer Entities and Object Exchange

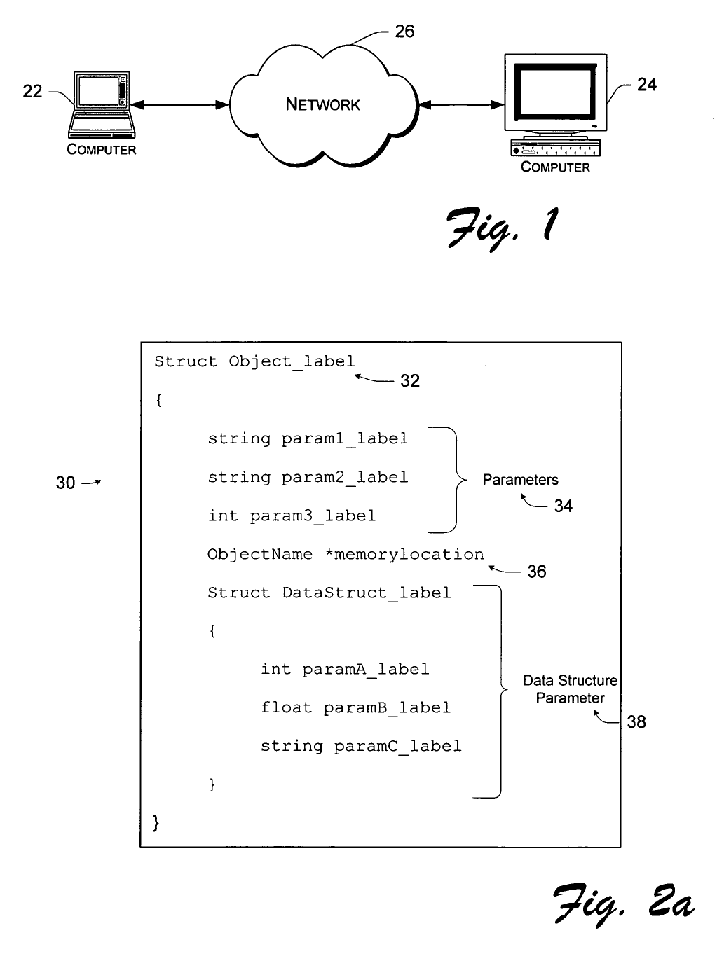

FIG. 1 shows two computers 22, 24. These computers are connected to each other via a computer network 26. These computers may be desktop, laptop, handheld, server, or mainframe computers. These computers may be a computer capable of connecting to a communications network and exchanging messages. More particularly, a message comprises at least one serialized object. The network 26 may be a private network (e.g., a local or wide area network) or a public network (e.g., the Internet).

Herein, an entity is understood to be a computer component that is capable of exchanging messages containing at least one serialized object with another entity. Such an entity may be in an object-oriented, decentralized, distributed network environment. Alternatively, such an entity may be in a local, object-oriented computing environment. For example, an entity may be a computer, a computer system, a component of a computer, or an application running on a computer.

Herein, an originating entity (i.e., originator) is an entity that serialized an object, inserts it into a message, and sends that message. A destination entity (i.e., ultimate destination) is an entity that receives the message, parses the message, and deserializes the serialized object in the message. The exemplary object persister is implemented by one or more computer entities within a local computing environment or within a distributed network environment.

SOAP

In the primary exemplary embodiment described herein, the object persister is implemented as part of a protocol called Simple Object Access Protocol (SOAP). In addition, the primary exemplary embodiment described herein employs XML (eXtensible Markup Language).

SOAP provides a simple and lightweight mechanism for exchanging structured and typed information between peers in a decentralized, distributed environment using XML. SOAP does not itself define any application semantics such as a programming model or implementation specific semantics; rather it defines a simple mechanism for expressing application semantics by providing a modular packaging model and an encoding mechanism for encoding data within modules. This allows SOAP to be used in a large variety of systems ranging from general messaging systems to object-oriented programming systems to Remote Procedure Calls (RPC).

SOAP consists of two parts:

The SOAP envelope construct defines an overall framework for expressing what is in a message; who should deal with it, and whether it is optional or mandatory.

The SOAP encoding mechanism defines a serialization mechanism for exchange of application-defined datatypes.

The SOAP envelope portion (which may be called the “message exchanger”) is described in more detail in appendix A and in co-pending patent application, entitled “Messaging Method, Apparatus, and Article of Manufacture”, which was filed Apr. 27, 2000 and is assigned to the Microsoft Corporation. The co-pending application is incorporated by reference.

The SOAP encoding mechanism includes the primarily exemplary embodiment of an object persister described herein. Furthermore, SOAP is described in more detail in Appendix A.

XML and HTTP

Unlike HTML (HyperText Markup Language), XML has sufficient flexibility so that it is possible to exchange serialized objects over a network. XML has no standard mechanism to accomplish this. However, the exemplary object persister provides such a mechanism to accomplish this.

Using the exemplary object persister, an object is serialized and encoded into XML and sent over a network to a destination entity. With the exemplary object persister, the serialized object is inserted into a message and sent over a network using HTTP (HyperText Transport Protocol). However, other transport protocols may be employed.

Serialization Format

The elements in the serialization format of the exemplary object persister represent different elements in an object data structure. The format is easily readable by humans and machines. The format also compensates for potentially infinite cycles where objects call each other.

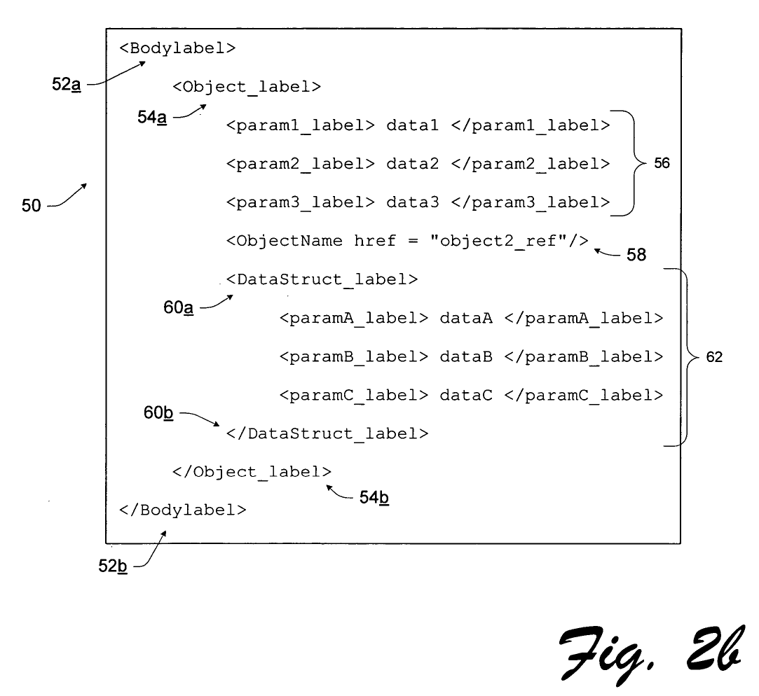

In FIG. 2a, a data structure 30 of an exemplary object is shown. This is only an example and those of ordinary skill in the art will understand that an object can have nearly an infinite number of arrangements and labels. Data structure 30 is merely an example of one possible arrangement and labels. The object is called “Object_label” at 32. The data structure includes various parameters such as those shown at 34, 36, and 38.

A parameter may be one of many “datatypes” or “types”. Datatype is a concept understood by those of ordinary skill in the art. There are two main forms of datatypes: simple and complex.

A parameter is a simple datatype when it is defined to be a most fundamental type of data. In other words, a simple datatype cannot be broken down into one or more simpler types. Examples of a simple data type include character, string, integer, and floating point.

A parameter is a complex datatype when it composed of one or more other datatypes, which may include simple and other complex datatypes. A complex datatype may also be a customized datatype, which is defined within the object or by a reference to a definition outside of the object.

In FIG. 2a, parameters 34 are simple datatypes. Param1_label and param2 are strings. Param3_label is an integer. Parameter 36 defines the name of another object called “ObjectName” and provides is memory address at “*memorylocation.” This parameter includes another object within the data structure of the main object by naming it and providing its address.

The object's data structure also includes a parameter that is itself a data structure at 38. This data structure parameter defines additional parameters. In particular, the addition parameters include paramA_label (an integer), paramB_label (a floating point), and paramC_label (a string).

FIG. 2b illustrates a serialized representation of the exemplary object shown in FIG. 2a that may be generated by the exemplary object persister. In addition to preserving the parameter labels and hieratical structure of the object in FIG. 2a, the exemplary object persister preserves the current “status” of the object at a moment in time. The “status” of the object is represented by the data actually stored within the data structure of the object at the moment that the object is serialized.

As discussed above (and shown in Appendix A), the serialized object of the exemplary object persister is sent within a message over a network. FIG. 2b shows the XML tags (“<Bodylabel>” and “</Bodylabel>” ) used to define the boundaries of the body of a message. The serialized object is typically inserted inside the body.

FIG. 2b shows the XML tags (“<Object_label>” at 54a and “</Object_label>” at 54b) that define the boundaries of the data structure of the serialized object (of FIG. 2a). Note that the same name “Object_label” is used in the label 32 of FIG. 2a and in the tags 54a, 54b of FIG. 2b.

Corresponding to the parameters 34 of FIG. 2a are serialized parameters 56 in FIG. 2b. Each parameter has a pair of tags that define the boundaries of the parameter. For example, “param2_label” has a beginning tag <param2_label>and an ending label </param2_label>. Between these tags is the serialized data of the parameter that was saved at the moment the object was serialized. For example, param3_label is an integer data type (see parameters 34 of FIG. 2a); therefore, data3 (in parameters 56 of FIG. 2b) may be any integer such as “43.”

In FIG. 2b, none of the datatypes of the parameters is shown or defined. The datatypes may be defined internally or externally. Internal definition describes when datatype definitions for each parameter are specified within the message containing the serialized object. External definition describes when datatype definitions for each parameter are specified outside of the message, but the message contains one or more references to the location where the definitions are located.

FIG. 2b also shows a reference to another object at 58. In this parameter, an object called “ObjectName” is specified and it is located by a reference label “object2_ref”. Rather than including a copy of the “ObjectName” object within the serialized object, the exemplary persister simply includes the reference to the object. Referencing of embedded objects instead of including them lessens the data that must be serialized and sent over a network.

The object being serialized may be quite large and include redundant information if it includes multiple references to another object or if a referenced object includes references to still other objects. Suppose, for example, an object being serialized includes references to ObjectA, ObjectB, ObjectC, ObjectD, and ObjectE. ObjectB includes references to ObjectD and ObjectE. In addition, ObjectE includes references to ObjectsA-D. If all referenced objects were included within the serialized object (as is conventional), then most of the referenced object would be included multiple times. This is redundant. The exemplary object persister avoids this problem by including references to an object rather than the object itself.

Furthermore, the serialization of an object may be stuck an infinite loop if the object includes a references to itself or if a referenced object refers back to the object being serialized. If the serialization process includes the referenced object within the serialized object (as is conventional), then the serialized object may include itself in itself in itself in itself in itself etc. The exemplary object persister avoids this problem by including references to an object rather than the object itself. Thus, an object will simply include a reference to itself.

In FIG. 2b, the serialized object also includes a parameter that is a data structure at 62. This data structure parameter is bounded by a pair of XML tags, “<DataStruct_label>” at 60a and “</DataStruct_label>” at 60b.

The serialized object bounded by tags 54a and 54b may also be called a data structure element or simply “datastruct” element. The tags are part of the datastruct element. Everything within these tags is content of the datastruct element. The parameters (such as 56, 58, and 62) are part of the contents of the datastruct element.

Serialization Example

Below is an example of serialization of an object. The exemplary object's data structure in pseudocode:

| Struct StockQuote | |
|---|---|
| { | |
| string | company; |
| string | stocksymbol; |
| int | annual_high; |
| int | annual_low; |
| int | current_price; |
| } | |

Below is a serialized representation of an object (based upon the above structure in pseudocode) generated in accordance with the exemplary object persister:

```
<StockQuote>
  <company> CompanyX </company>
  <stocksymbol> CPYX </stocksymbol>
  <annual_high> 101 </annual high>
  <annual_low> 72 </annual_low>
  <current_price> 93 </current_price>
</StockQuote>
```

Exemplary Methodological Implementation of the Object Persister

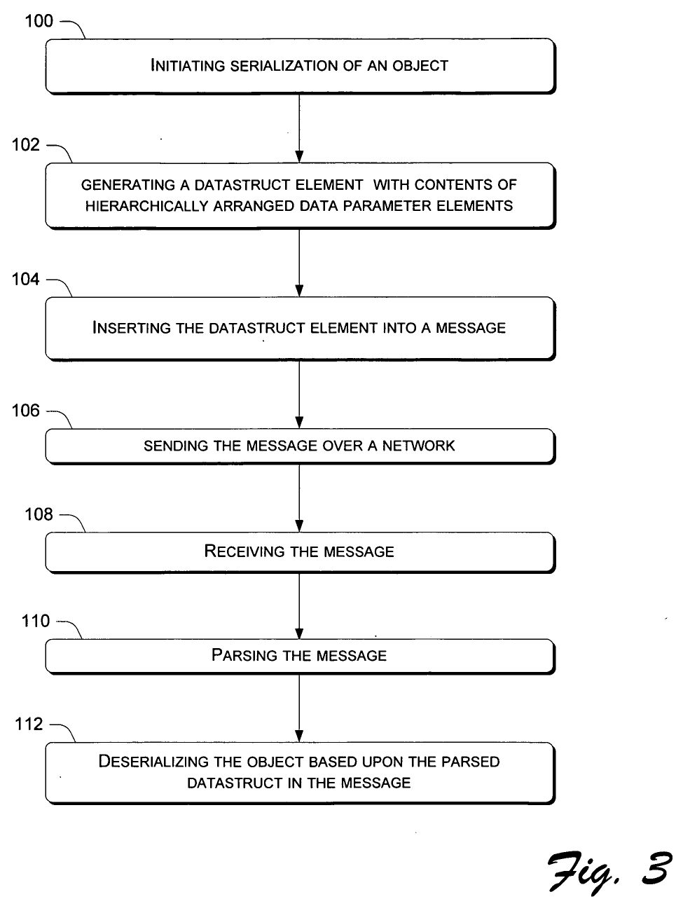

FIG. 3 shows an exemplary methodological implementation of the object persister. At 100, the object serialization is initiated. This may be the result of a specific manual command or an automatic command of another program or object. If an object is being sent from an originating entity (such as entity 22 in FIG. 1) to a destination entity (such as entity 24 in FIG. 1), then the object must be serialized. Thus, serialization may be initiated by a request from the destination entity for the object.

At 102 of FIG. 3, the object is serialized in the manner generally described above in the Serialization Format section. More specifically, a datastruct element is generated with contents. This datastruct element represents and preserves the hierarchical organization of the object data structure. The datastruct element is bounded by a pair of datastuct tags (such as tags 54a and 54b of FIG. 2b). The contents are inside the tags.

The contents of the data struct element include one or more data parameter elements (such as parameters 56, 58, and 62 in FIG. 2b). Each data parameter element represents and preserves the organization and label of the parameters of the object. Each parameter element is bounded by a pair of parameter tags (such as “<param2_label>” and “</param2_label>” of the first parameter in the parameters 56 in FIG. 2b). Between each pair of parameter tag is data that represents the value of that parameter when that object was serialized. The datatypes of the parameters are defined either internally or externally.

At 104 of FIG. 3, the datastruct element is inserted into the body of a message. At 106, the message is sent from the originating entity to the destination entity via a network. In the exemplary object persister, the message may be sent over the Internet using the HTTP protocol.

At 108 and 110, the destination entity receives the message and parses it. At 112, the serialized object in the message is deserialized. The new object has the same hierarchical structure and arrangement of the original object (that was serialized). It also includes the data of that object at the moment that the object was serialized.

Exemplary Computing Environment

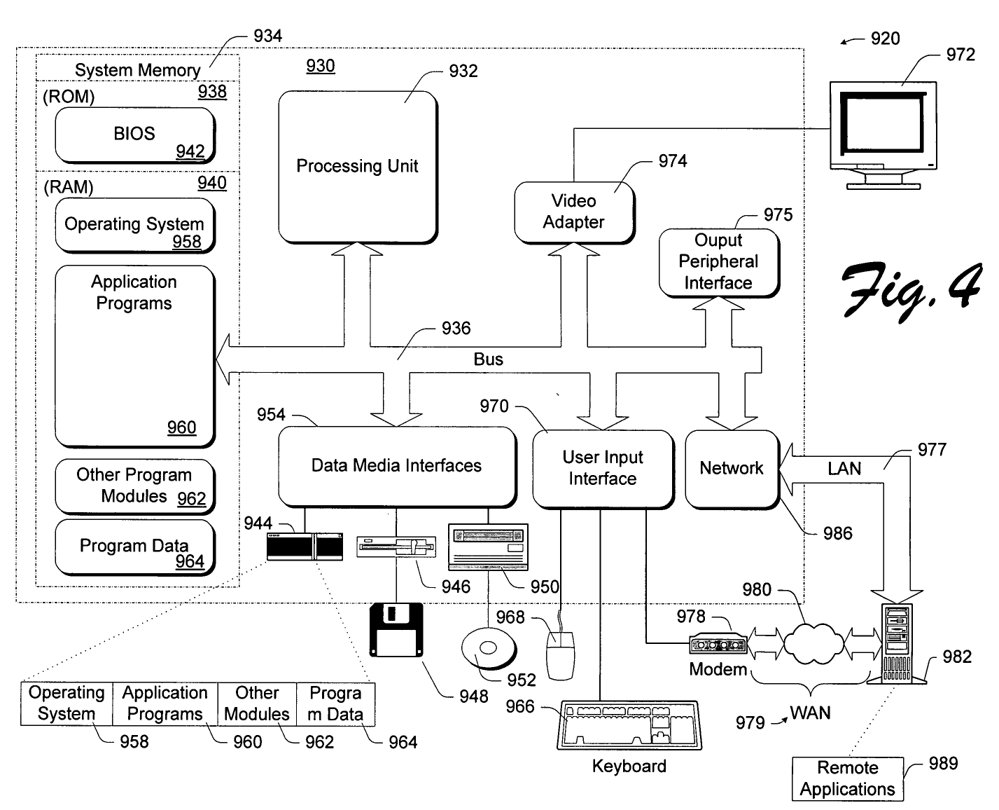

FIG. 4 illustrates an example of a suitable computing environment 920 on which the exemplary object persister may be implemented.

Exemplary computing environment 920 is only one example of a suitable computing environment and is not intended to suggest any limitation as to the scope of use or functionality of the exemplary object persister. Neither should the computing environment 920 be interpreted as having any dependency or requirement relating to any one or combination of components illustrated in the exemplary computing environment 920.

The exemplary object persister is operational with numerous other general purpose or special purpose computing system environments or configurations. Examples of well known computing systems, environments, and/or configurations that may be suitable for use with the exemplary object persister include, but are not limited to, personal computers, server computers, think clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The exemplary object persister may be described in the general context of computer-executable instructions, such as program modules, being executed by a computer. Generally, program modules include routines, programs, objects, components, data structures, etc. that perform particular tasks or implement particular abstract data types. The exemplary object persister may also be practiced in distributed computing environments where tasks are performed by remote processing devices that are linked through a communications network. In a distributed computing environment, program modules may be located in both local and remote computer storage media including memory storage devices.

As shown in FIG. 4, the computing environment 920 includes a general-purpose computing device in the form of a computer 930. The components of computer 920 may include, by are not limited to, one or more processors or processing units 932, a system memory 934, and a bus 936 that couples various system components including the system memory 934 to the processor 932.

Bus 936 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) buss also known as Mezzanine bus.

Computer 930 typically includes a variety of computer readable media. Such media may be any available media that is accessible by computer 930, and it includes both volatile and non-volatile media, removable and non-removable media.

In FIG. 4, the system memory includes computer readable media in the form of volatile memory, such as random access memory (RAM) 940, and/or non-volatile memory, such as read only memory (ROM) 938. A basic input/output system (BIOS) 942, containing the basic routines that help to transfer information between elements within computer 930, such as during start-up, is stored in ROM 938. RAM 940 typically contains data and/or program modules that are immediately accessible to and/or presently be operated on by processor 932.

Computer 930 may further include other removable/non-removable, volatile/non-volatile computer storage media. By way of example only, FIG. 4 illustrates a hard disk drive 944 for reading from and writing to a non-removable, non-volatile magnetic media (not shown and typically called a “hard drive”), a magnetic disk drive 946 for reading from and writing to a removable, non-volatile magnetic disk 948 (e.g., a “floppy disk”), and an optical disk drive 950 for reading from or writing to a removable, non-volatile optical disk 952 such as a CD-ROM, DVD-ROM or other optical media. The hard disk drive 944, magnetic disk drive 946, and optical disk drive 950 are each connected to bus 936 by one or more interfaces 954.

The drives and their associated computer-readable media provide nonvolatile storage of computer readable instructions, data structures, program modules, and other data for computer 930. Although the exemplary environment described herein employs a hard disk, a removable magnetic disk 948 and a removable optical disk 952, it should be appreciated by those skilled in the art that other types of computer readable media which can store data that is accessible by a computer, such as magnetic cassettes, flash memory cards, digital video disks, random access memories (RAMs), read only memories (ROM), and the like, may also be used in the exemplary operating environment.

A number of program modules may be stored on the hard disk, magnetic disk 948, optical disk 952, ROM 938, or RAM 940, including, by way of example, and not limitation, an operating system 958, one or more application programs 960, other program modules 962, and program data 964.

A user may enter commands and information into computer 930 through input devices such as keyboard 966 and pointing device 968 (such as a “mouse”). Other input devices (not shown) may include a microphone, joystick, game pad, satellite dish, serial port, scanner, or the like. These and other input devices are connected to the processing unit 932 through an user input interface 970 that is coupled to bus 936, but may be connected by other interface and bus structures, such as a parallel port, game port, or a universal serial bus (USB).

A monitor 972 or other type of display device is also connected to bus 936 via an interface, such as a video adapter 974. In addition to the monitor, personal computers typically include other peripheral output devices (not shown), such as speakers and printers, which may be connected through output peripheral interface 975.

Computer 930 may operate in a networked environment using logical connections to one or more remote computers, such as a remote computer 982. Remote computer 982 may include many or all of the elements and features described herein relative to computer 930.

Logical connections shown in FIG. 4 are a local area network (LAN) 977 and a general wide area network (WAN) 979. Such networking environments are commonplace in offices, enterprise-wide computer networks, intranets, and the Internet.

When used in a LAN networking environment, the computer 930 is connected to LAN 977 network interface or adapter 986. When used in a WAN networking environment, the computer typically includes a modem 978 or other means for establishing communications over the WAN 979. The modem 978, which may be internal or external, may be connected to the system bus 936 via the user input interface 970, or other appropriate mechanism.

Depicted in FIG. 4, is a specific implementation of a WAN via the Internet. Over the Internet, computer 930 typically includes a modem 978 or other means for establishing communications over the Internet 980. Modem 978, which may be internal or external, is connected to bus 936 via interface 970.

In a networked environment, program modules depicted relative to the personal computer 930, or portions thereof, may be stored in a remote memory storage device. By way of example, and not limitation, FIG. 4 illustrates remote application programs 989 as residing on a memory device of remote computer 982. It will be appreciated that the network connections shown and described are exemplary and other means of establishing a communications link between the computers may be used.

Exemplary Operating Environment

FIG. 4 illustrates an example of a suitable operating environment 920 in which the exemplary object persister may be implemented. Specifically, the exemplary object persister is implemented by any program 960-962 or operating system 958 in FIG. 4.

The operating environment is only an example of a suitable operating environment and is not intended to suggest any limitation as to the scope of use of functionality of the bw-meter described herein. Other well known computing systems, environments, and/or configurations that may be suitable for use with the bw-meter include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

Computer-Executable Instructions

An implementation of the exemplary object persister may be described in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Computer Readable Media

An implementation of the exemplary object persister may be stored on or transmitted across some form of computer readable media. Computer readable media can be any available media that can be accessed by a computer. By way of example, and not limitation, computer readable media may comprise computer storage media and communications media.

Computer storage media include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Communication media typically embodies computer readable instructions, data structures, program modules, or other data in a modulated data signal such as carrier wave or other transport mechanism and included any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Conclusion

Although the object persister has been described in language specific to structural features and/or methodological steps, it is to be understood that the object persister defined in the appended claims is not necessarily limited to the specific features or steps described. Rather, the specific features and steps are disclosed as preferred forms of implementing the claimed object persister.

Appendix A

Appendix A includes a copy of a provisional application filed on Mar. __, 2000 and submitted to W3C organization for considerations by their standards committee.

SOAP: Simple Object Access Protocol

W3C Technical Report 23 Mar. 2000

Abstract

SOAP is a lightweight protocol for exchange of information in decentralized, distributed environments. It is an XML based protocol that consists of two parts: an envelope for handling extensibility and modularity and an encoding mechanism for representing types within the envelope. SOAP can potentially be used in combination with a variety of other protocols; however, the only bindings defined in this document describe how to use SOAP in combination with HTTP and HTTP Extension Framework.

Introduction

SOAP provides a simple and lightweight mechanism for exchanging structured and typed information between peers in a decentralized, distributed environment using XML. SOAP does not itself define any application semantics such as a programming model or implementation specific semantics; rather it defines a simple mechanism for expressing application semantics by providing a modular packaging model and an encoding mechanism for encoding data within modules. This allows SOAP to be used in a large variety of systems ranging from messaging systems to RPC.

SOAP consists of two parts:

The SOAP envelope construct defines an overall framework for expressing what is in a message; who should deal with it, and whether it is optional or mandatory.

The SOAP encoding mechanism defines a serialization mechanism for exchange of application-defined datatypes.

Although the envelope and the encoding both are an integral part of SOAP they are functionally orthogonal and are defined in different namespaces in order to promote simplicity through modularity.

In addition to the SOAP envelope and encoding, this specification defines two protocol bindings that describe how a SOAP message can be carried in HTTP messages either with or without the HTTP Extension Framework.

Notational Conventions

The keywords “MUST”, “MUST NOT”, “REQUIRED”, “SHALL”, “SHALL NOT”, “SHOULD”, “SHOULD NOT”, “RECOMMENDED”, “MAY”, and “OPTIONAL” in this document are to be interpreted as described in RFC-2119 [2].

The namespace prefixes “SOAP-ENV” and “SOAP-ENC” are used in this document to represent the prefixes that actually appears in the XML instance and are associated with the SOAP namespaces

“http://schemas.xmlsoap.org/soap/envelope/” and

“http://schemas.xmlsoap.org/soap/encoding/” respectively.

Throughout this document, the namespace prefix “xsi” is assumed to be associated with the URI “http://www.w3.org/1999/XMLSchema/instance” which is defined in the XML Schemas specification [11].

Namespace URIs of the general form “some-URI” represent some application-dependent or context-dependent URI [4].

This specification uses the augmented Backus-Naur Form (ABNF) as described in RFC-2234 [3] for certain constructs.

Examples of SOAP Messages

In this example, a GetLastTradePrice SOAP request is sent to a StockQuote service. The request takes a string parameter, ticker, and returns a float in the SOAP response. The SOAP Envelope element is the top element of the XML document representing the SOAP message. XML namespaces are used to disambiguate SOAP identifiers from application specific identifiers. The example illustrates the HTTP bindings. It is worth noting that the rules governing XML payload format in SOAP are entirely independent of the fact that the payload is carried in HTTP.

### EXAMPLE 1

### SOAP Message Embedded in HTTP Request

```
    POST /StockQuote HTTP/1.1
Host: www.stockquoteserver.com
Content-Type: text/xml
Content-Length: nnnn
SOAPAction: “Some-URI”
<SOAP-ENV: Envelope
  xmlns:SOAP-ENV=“http://schemas.xmlsoap.org/soap/envelope/”
  SOAP-
ENV:encodingStyle=“http://schemas.xmlsoap.org/soap/encoding/”>
    <SOAP-ENV:Body>
      <m:GetLastTradePrice xmlns:m=“Some-URI”>
        <symbol>DIS</symbol>
      </m:GetLastTradePrice>
    </SOAP-ENV:Body>
</SOAP-ENV:Envelope>
```

Following is the response message containing the HTTP message with the SOAP message as the payload:

### EXAMPLE 2

### SOAP Message Embedded in HTTP Response

```
    HTTP/1.1 200 OK
Content-Type: text/xml
Content-Length: nnnn
<SOAP-ENV:Envelope
  xmlns:SOAP-ENV=“http://schemas.xmlsoap.org/soap/envelope/”
  SOAP-
ENV:encodingStyle=“http://schemas.xmlsoap.org/soap/encoding/”/>
  <SOAP-ENV:Body>
    <m:GetLastTradePriceResponse xmlns:m=“Some-URI”>
      <Price>34.5</Price>
    </m:GetLastTradePriceResponse>
  </SOAP-ENV:Body>
</SOAP-ENV:Envelope>
```

The SOAP Message Exchange Model

SOAP does not define a specific message exchange pattern, as this is defined by the protocol bindings to a specific protocol such as HTTP. In other words, SOAP itself is not a request/response or a one-way message protocol. However, it can be used within the context of a request/response protocol or a one-way message protocol. For example, in the context of HTTP, SOAP inherits the HTTP message exchange pattern of requests and responses.

SOAP does however define the notion of a message path that consists of the originator of the message, the ultimate destination, and potentially one or more intermediaries that may take part in the message path.

A SOAP application receiving a SOAP message MUST process that message by performing the following actions in the order listed below:

1. Identify all parts of the SOAP message intended for that application

2. Verify that all mandatory parts identified in step 1 are supported by the application for this message and process them accordingly. If this is not the case then discard the message. The processor MAY ignore optional parts identified in step 1 without affecting the outcome of the processing.

3. If the SOAP application is not the ultimate destination of the message then remove all parts identified in step 1 before forwarding the message.

2. 3. Relation to XML

All SOAP messages are encoded using XML.

A SOAP application SHOULD include the proper SOAP namespace on all elements and attributes defined by SOAP in messages that it generates. A SOAP application MUST be able to process SOAP namespaces in messages that it receives. It MUST discard messages that have incorrect namespaces and it MAY process SOAP messages without SOAP namespaces as though they had the correct SOAP namespaces.

SOAP defines two namespaces:

The SOAP envelope has the namespace identifier “http:H/schemas.xmlsoap.org/soap/envelope/”

The SOAP serialization has the namespace identifier “http://schemas.xmlsoap.org/soap/encoding/”

SOAP uses the local, unqualified “id” attribute of type “ID” to specify the unique identifier of an encoded element. SOAP uses the local, unqualified attribute “href” of type “uri-reference” to specify a reference to that value, in a manner conforming to the XML Specification [7], XML Schema Specification [11], and XML Linking Language Specification [9].

With the exception of the SOAP mustUnderstand attribute and the SOAP actor attribute, it is generally permissible to have attributes and their values appear in XML instances or alternatively in schemas, with equal effect. That is, declaration in a DTD or schema with a default or fixed value is semantically equivalent to appearance in an instance.

SOAP Envelope

A SOAP message is an XML document that consists of a mandatory SOAP envelope, an optional SOAP header, and a mandatory SOAP body. This XML document is referred to as a SOAP message for the rest of this specification. The namespace identifier for the elements and attributes defined in this section is “http://schemas.xmlsoap.org/soap/envelope/”. A SOAP message contains the following:

The Envelope is the top element of the XML document representing the message.

The Header is a generic mechanism for adding features to a SOAP message in a decentralized manner without prior agreement between the communicating parties. SOAP defines a few attributes that can be used to indicate who should deal with a feature and whether it is optional or mandatory.

The Body is a container for mandatory information intended for the ultimate recipient of the message. SOAP defines one element for the body, which is the Fault element used for reporting errors.

The grammar rules are as follows:

1. Envelope

The element name is “Envelope”.

The element MUST be present in a SOAP message

The element MAY contain namespace declarations as well as additional attributes. If present, such additional attributes MUST be namespace-qualified. Similarly, the element MAY contain additional sub elements. If present these elements MUST be namespace-qualified and MUST follow the SOAP Body element.

2. Header

The element name is “Header”.

The element MAY be present in a SOAP message. If present, the element MUST be the first immediate child element of the SOAP Envelope element.

The element MAY contain a set of header entries each being an immediate child element of the SOAP Header element. All immediate child elements of the SOAP Header element MUST be namespace-qualified.

3. Body

The element name is “Body”.

The element MUST be present in a SOAP message and MUST be an immediate child element of the SOAP Envelope element. It MUST directly follow the SOAP Header element if present. Otherwise it MUST be the first immediate child element of the SOAP Envelope element.

The element MAY contain a set of body entries each being an immediate child element of the SOAP Body element. Immediate child elements of the SOAP Body element MAY be namespace-qualified. SOAP defines the SOAP Fault element, which is used to indicate error messages.

SOAP EncodingStyle Attribute

The, SOAP encodingStyle global attribute can be used to indicate the serialization rules used in a SOAP message. This attribute MAY appear on any element, and is scoped to that element's contents and all child elements not themselves containing such an attribute, much as an XML namespace declaration is scoped. There is no default encoding defined for a SOAP message.

The attribute value is an ordered list of one or more URIs identifying the serialization rule or rules that can be used to deserialize the SOAP message indicated in the order of most specific to least specific. Examples of values are

“http://schemas.xmlsoap.org/soap/encoding/”
“http://my.host/encoding/restricted http://my.host/encoding/”
“ ”

The serialization rules defined by SOAP are identified by the URI “http://schemas.xmlsoap.org/soap/encoding/”. Messages using this particular serialization SHOULD indicate this using the SOAP encodingStyle attribute. In addition, all URIs syntactically beginning with “http://schemas.xmlsoap.org/soap/encoding//” indicate conformance with the SOAP encoding rules.

A value of the zero-length URI (“”) explicitly indicates that no claims are made for the encoding style of contained elements. This can be used to turn off

Envelope Versioning Model

SOAP does not define a traditional versioning model based on major and minor version numbers. A SOAP message MUST have an Envelope element associated with the “http://schemas.xmlsoap.org/soap/envelope/” namespace. If a message is received by a SOAP application in which the SOAP Envelope element is associated with a different namespace, the application MUST treat this as a version error and discard the message. If the message is received through a request/response protocol such as HTTP, the application MUST respond with a SOAP VersionMismatch faultcode message using the SOAP “http://schemas.xmlsoap.org/soap/envelope/” namespace.

SOAP Header

SOAP provides a flexible mechanism for extending a message in a decentralized and modular way without prior knowledge between the communicating parties. Typical examples of extensions that can be implemented as header entries are authentication, transaction management, payment etc.

The Header element is encoded as the first immediate child element of the SOAP Envelope XML element. All immediate child elements of the Header element are called header entries.

The encoding rules for header entries are as follows:

1. A header entry is identified by its fully qualified element name, which consists of the namespace URI and the local name. All immediate child elements of the SOAP Header element MUST be namespace-qualified.

2. The SOAP encodingStyle attribute MAY be used to indicate the encoding style used for the header entries.

3. The SOAP mustUnderstand attribute and SOAP actor attribute MAY be used to indicate how to process the entry and by whom.

Use of Header Attributes

The SOAP Header attributes defined in this section determine how a recipient of a SOAP message should process the message. A SOAP application generating a SOAP message SHOULD only use the SOAP Header attributes on immediate child elements of the SOAP Header element. The recipient of a SOAP message MUST ignore all SOAP Header attributes that are not applied to an immediate child element of the SOAP Header element.

An example is a header with an element identifier of “Transaction”, a “mustUnderstand” value of “1”, and a value of 5. This would be encoded as follows:

```
    <SOAP-ENV:Header>
  <t:Transaction
    xmlns:t=“some-URI” SOAP-ENV:mustUnderstand=“1”>
      5
  </t:Transaction>
</SOAP-ENV:Header>
```

SOAP Actor Attribute

A SOAP message travels from the originator to the ultimate destination, potentially by passing through a set of SOAP intermediaries along the message path. A SOAP intermediary is an application that is capable of both receiving and forwarding SOAP messages. Both intermediaries as well as the ultimate destination are identified by a URI.

Not all parts of a SOAP message may be intended for the ultimate destination of the SOAP message but may be intended for one or more of the intermediaries on the message path. The role of a recipient of a header element is similar to that of accepting a contract in that it cannot be extended beyond the recipient. That is, a recipient receiving a header element MUST NOT forward that header element to the next application in the SOAP message path. The recipient MAY insert a similar header element but in that case, the contract is between that application and the recipient of that header element.

The SOAP actor global attribute can be used to indicate the recipient of a header element. The value of the SOAP actor attribute is a URI. The special URI “http://schemas.xmlsoap.org/soap/actor/next” indicates that the header element is intended for the very first SOAP application that processes the message. This is similar to the hop-by-hop scope model represented by the Connection header field in HTTP.

Omitting the SOAP actor attribute indicates that the sender does not know or does not care which resource should process the header element. The SOAP actor global header element attribute can be used to indicate the entity that is going to act on that header element. The entity identified by the SOAP actor can be thought of as the application resource that a header element is intended for. This can for example be used to indicate whether a header element is intended for an entity of the recipient that takes part of the application or as part of the routing infrastructure.

This attribute MUST appear in the SOAP message instance and not in a schema or DTD in order to be effective.

SOAP MustUnderstand Attribute

The SOAP mustUnderstand global attribute can be used to indicate whether a header entry is mandatory or optional for the recipient to process. The recipient of a header entry is defined by the SOAP actor attribute. The value of the mustUnderstand attribute is either “1” or “0”. The absence of the SOAP mustUnderstand attribute is semantically equivalent to its presence with the value “0”.

If a header element is tagged with a SOAP mustUnderstand attribute with a value of “1”, the recipient of that header entry either MUST obey the semantics (as conveyed by its element name, contextual setting, and so on) and process correctly to those semantics, or MUST fail processing the message.

The SOAP mustUnderstand attribute allows for robust evolution. Elements tagged with the SOAP mustUnderstand attribute with a value of “1” MUST be presumed to somehow modify the semantics of their parent or peer elements. Tagging elements in this manner assures that this change in semantics will not be silently (and, presumably, erroneously) ignored by those who may not fully understand it.

This attribute MUST appear in the instance and not in a schema or DTD in order to be effective.

SOAP Body

The SOAP Body element provides a simple mechanism for exchanging mandatory information intended for the ultimate recipient of the message. Typical uses of the Body element include marshalling RPC calls and error reporting.

The Body element is encoded as an immediate child element of the SOAP Envelope XML element. If a Header element is present then the Body element MUST immediately follow the Header element, otherwise it MUST be the first immediate child element of the Envelope element.

All immediate child elements of the Body element are called body entries and each body entry is encoded as an independent element within the SOAP Body element.

The encoding rules for body entries are as follows:

1. A body entry is identified by its fully qualified element name, which consists of the namespace URI and the local name. Immediate child elements of the SOAP Body element MAY be namespace-qualified.

2. The SOAP encodingStyle attribute MAY be used to indicate the encoding style used for the body entries.

SOAP defines one body entry, which is the Fault entry used for reporting errors.

Relationship Between SOAP Header and Body

While the Header and Body are defined as independent elements, they are in fact related. The relationship between a body entry and a header entry is as follows: A body entry is semantically equivalent to a header entry intended for the default actor and with a SOAP mustUnderstand attribute with a value of “1”. The default actor is indicated by not using the actor attribute.

SOAP Fault

The SOAP Fault element is used to carry error and/or status information within a SOAP message. If present, the SOAP Fault element MUST appear as a body entry and MUST NOT appear more than once within a Body element.

The SOAP Fault element defines the following four subelements:

Faultcode

The faultcode element is intended for use by software to provide an algorithmic mechanism for identifying the fault. The faultcode MUST be present in a SOAP Fault element and the faultcode value MUST be a qualified name. SOAP defines a small set of SOAP fault codes covering basic SOAP faults.

Faultstring

The faultstring element is intended to provide a human readable explanation of the fault and is not intended for algorithmic processing. The faultstring element is similar to the ‘Reason-Phrase’ defined by HTTP (see [5]). It MUST be present in a SOAP Fault element and SHOULD provide at least some information explaining the nature of the fault.

Faultactor

The faultactor element is intended to provide information about who caused the fault to happen within the message path. It is similar to the SOAP actor attribute but instead of indicating the destination of the header entry, it indicates the source of the fault. The value of the faultactor attribute is a URI identifying the source. Applications that do not act as the ultimate destination of the SOAP message MUST include the faultactor element in a SOAP Fault element. The ultimate destination of a message MAY use the faultactor element to indicate explicitly that it generated the fault.

Detail

The detail element is intended for carrying application specific error information related to the Body element. It MUST be present if the contents of the Body element could not be successfully processed. It MUST NOT be used to carry information about error information belonging to header entries. Detailed error information belonging to header entries MUST be carried within header entries.

The absence of the detail element in the Fault element indicates that the fault is not related to processing of the Body element. This can be used to distinguish whether the Body element was processed or not in case of a fault situation.

All immediate child elements of the detail element are called detail entries and each detail entry is encoded as an independent element within the detail element.

The encoding rules for detail entries are as follows:

1. A detail entry is identified by its fully qualified element name, which consists of the namespace URI and the local name. Immediate child elements of the detail element MAY be namespace-qualified.

2. The SOAP encodingStyle attribute MAY be used to indicate the encoding style used for the detail entries.

Other Fault subelements MAY be present, provided they are namespace-qualified.

SOAP Fault Codes

The faultcode values defined in this section MUST be used in the faultcode element when describing faults defined by this specification. The namespace identifier for these faultcode values is “http://schemas.xmlsoap.org/soap/envelope/”. Use of this space is recommended (but not required) in the specification of methods defined outside of the present specification.

The default SOAP faultcode values are defined in an extensible manner that allows for new SOAP faultcode values to be defined while maintaining backwards compatibility with existing faultcode values. The mechanism used is very similar to the 1××, 2××, 3×× etc basic status classes classes defined in HTTP (see [5]). However, instead of integers, they are defined as XML qualified names (see [8]). The character “.” (dot) is used as a separator of faultcode values indicating that what is to the left of the dot is a more generic fault code value than the value to the right. Example

Client.Authentication

The set of faultcode values defined in this document is:

| Name | Meaning |
|---|---|
| VersionMismatch | The processing party found an invalid namespace |
| | for the SOAP Envelope element |
| MustUnderstand | An immediate child element of the SOAP Header |
| | element that was either not understood or not obeyed |
| | by the processing party contained a SOAP |
| | mustUnderstand attribute with a value of “1”. |
| Client | The processing party could not process the |
| | message because it was incorrectly formed or |
| | did not contain the appropriate information |
| | for the processing to succeed. |
| Server | The processing party was incapable of processing the |
| | message. |

SOAP Encoding

The SOAP encoding style uses a simple, traditional type system. A type either is a simple (scalar) type or is a complex type constructed as a composite of several parts, each with a type. This section defines a rule for serialization of a graph of typed objects. The namespace identifier for the elements and attributes defined in this section is “http://schemas.xmlsoap.org/soap/encoding/”. The encoding samples shown assume all namespace declarations are at a higher element level.

Rules for Encoding Types in XML

XML allows very flexible encoding of data. SOAP defines a narrower set of rules for encoding. This section defines the encoding rules at a high level, and the next section describes the encoding rules for specific types when they require more detail.

To describe encoding, the following terminology is used:

1. A “type” includes integer, string, point, street address, or similar. A type in SOAP corresponds to a scalar or structured type in a programming language or database. All values are of specific types.

2. A “complex type” is one that has distinct, named parts and whose encoding should reflect those named parts. A “simple type” is one without named parts. A structured type in a programming language is a complex type, and so is an array.

3. The name of a named part of a complex type is called an “accessor.”

4. If only one accessor can reference it, a value is considered “single-reference” for a given schema. If referenced by more than one, actually or potentially in a given schema, it is “multi-reference.” Therefore, it is possible for a certain type to be considered “single-reference” in one schema and “multi-reference” in another schema.

5. Syntactically, an element may be “independent” or “embedded.” An independent element is any element appearing at the top level of a serialization. All others are embedded elements.

The rules are as follows:

1. Elements are used to reflect either accessors or instances of types.

Embedded elements always reflect accessors. Independent elements always reflect instances of types. When reflecting an accessor, the name of the element gives the name of the accessor. When reflecting an instance of a type, the name of the element typically gives the name of the type (but see rule 11).

2. A call or response/fault is always encoded as an independent element.

3. Accessors are always encoded as embedded elements.

4. A value (simple or compound) is encoded as element content, either of an element reflecting an accessor to the value or of an element reflecting an instance of that type.

5. A simple value is encoded as character data, that is, without any sub elements according to Part II of the XML Schemas specification [11].

6. Strings and byte arrays are multi-reference simple types, but special rules allow them to be represented efficiently for common cases. An accessor to a string or byte-array value MAY have an attribute named “id” and of type “ID” per the XML Specification [7]. If so, all other accessors to the same value are encoded as empty elements having a local, unqualified attribute named “href” and of type “uri-reference” per the XML Schema Specifications [11], with the href containing a URI fragment identifier referencing the single element containing the value.

7. It is permissible to encode several references to a simple value as though these were references to several single-reference values, but only when from context it is known that the meaning of the XML instance is unaltered.

8. A complex value is encoded as a sequence of elements, each named according to the accessor it reflects.

9. A multi-reference simple or complex value is encoded as an independent element containing a local, unqualified attribute named “id” and of type “ID” per the XML Specification [7]. Each accessor to this value is an empty element having a local, unqualified attribute named “href” and of type “uri-reference” per the XML Schema Specifications [11], with the href containing a URI fragment identifier referencing the corresponding independent element.

10. Arrays are complex types. Arrays can be of one or more dimensions (rank) whose members are distinguished by ordinal position. An array value is represented as a series of elements reflecting the array, with members appearing in ascending ordinal sequence; for multi-dimensional arrays the dimension on the right side varies most rapidly. Arrays can be single-reference or multi-reference values. A single-reference embedded array is always encoded using an accessor element whose type is “SOAP-ENC:Array”. A multi-reference array is always encoded as an independent element whose type is “SOAP-ENC:Array”. The independent element or the accessor MUST contain a “SOAP-ENC:arrayType” attribute whose value specifies the type of the contained elements and the dimensions of the array. This is encoded as the type of the contained elements, as would appear in an xsi:type attribute, followed by “[”, followed by comma-separated lengths of each dimension, followed by “]”. The element type within the SOAP-ENC:ArrayType attribute acts as a type constraint (meaning that elements of substitutable types may appear). Note that the contained elements in an array may themselves be arrays. In such cases the element type is an array type. An array type is encoded as the type of its contained element, followed by “[”, followed by its rank encoded as a sequence of commas (one for each dimension except the first), followed by “]”. The independent or accessor element containing an array value MAY also contain a “SOAP-ENC:offset” attribute to indicate the starting position of a partially represented array. Each contained element of an array is encoded using the accessor named after its type (but see rule 11) which MAY contain a “SOAP-ENC:position” attribute conveying the position of that item in the enclosing array. Both “SOAP-ENC:offset” and “SOAP-ENC:position”attributes are encoded as “[”, followed by a comma-separated position in each dimension, followed by “]”, with offsets and positions based at 0. Note that none of the forgoing precludes an application storing data in an array and yet serializing the value of that data as a series of elements not marked as a SOAP-ENC:Array nor employing the attributes just described.

11. Any independent element or accessor element containing its value directly MAY optionally have an attribute named “xsi:type” whose value indicates the type of the element's contained value as described in “XML Schema Part 1: Structures” [10] and “XML Schema Part 2: Datatypes” [11]. However, its presence is mandatory on elements whose qualified element name does not clearly identify the type of the element.

12. A NULL value MAY be indicated by omission of the accessor element. A NULL value MAY also be indicated by an accessor element containing the attribute xsi:null=‘1’ and possibly other application-dependent attributes and values.

Simple Types

For simple types, SOAP adopts the types found in the section “Built-in datatypes” of the “XML Schema Part 2: Datatypes” Specification [11], along with the corresponding recommended representation thereof. Examples include:

| Type | Example |
|---|---|
| integer | 58502 |
| real | 314159265358979E+1 |
| negative-integer | −32768 |

Strings and arrays of bytes are encoded as multi-reference simple types.

String

For the purposes of this encoding discussion, a “String” is any sequence of characters meeting the production for CharData in the XML 1.0 specification. Note that many languages contain a datatype called “string” that permits values that do not match the CharData production. These values must be represented by using some datatype other than xsi:string.

A string is a multi-reference simple type. According to the rules of multi-reference simple types, the containing element of the string value MAY have an ID attribute; additional accessor elements MAY then have matching href attributes.

For example, two accessors to the same string could appear, as follows:

<greeting id=“String-0”>Hello</greeting>
<salutation href=“#String-0”/>

However, if the fact that both accessors reference the same instance of the string is immaterial, they may be encoded as though single-reference, as follows:

<greeting>Hello</greeting>
<salutation>Hello</salutation>

Enumerations

An enumeration is a single reference type whose value is encoded as one of the possible enumeration strings. In the following example EyeColor is an enumeration with the possible values of “Green”, “Blue”, or “Brown”:

```
<Person>
    <Name>Henry Ford</Name>
    <Age>32</Age>
      <EyeColor>Brown</EyeColor>
</Person>
```

Array of Bytes

An array of bytes is encoded as a multi-reference simple type. The recommended representation of an opaque array of bytes is the ‘base64’ encoding defined in XML Schemas [10][11], which uses the base64 encoding algorithm defined in 2045 [13]. However, the line length restrictions that normally apply to Base64 data in MIME do not apply in SOAP.

<picture xsi:type=“SOAP-ENC:Base64”>
aG93IG5vDyBicm73biBjb3cNCg==
</picture>

Polymorphic Accessor

Many languages allow accessors that can polymorphically access values of several types, each type being available at run time. A polymorphic accessor MUST contain an “xsi:type” attribute that describes the type of the actual value.

For example, a Polymorphic parameter named “cost” with a type of float would be encoded as follows:

<cost xsi:type=“float”>29.95</cost>

as contrasted with a cost parameter whose type is invariant, as follows:

<cost>29.95</cost>

Complex Types

Beyond the simple types, SOAP defines support for the following constructed types:

Records/structs

Arrays

Where appropriate and possible, the representation in SOAP of a value of a given type mirrors that used by practitioners of XML Schemas [10][11] and the common practice of the XML community at large.

Complex Values and References to Values

A complex value contains an ordered sequence of structural members. When the members have distinct names, as in an instance of a C or C++ struct, this is called a “struct,” and when the members do not have distinct names but instead are known by their ordinal position, this is called an “array.”

The members of a complex value are encoded as accessor elements. For a struct, the accessor element name is the member name. For an array, the accessor element name is the element type name and the sequence of the accessor elements follows the ordinal sequence of the members.

The following is an example of a struct of type Book:

```
<Book>
    <author>Henry Ford</author>
    <preface>Prefatory text</preface>
    <intro>This is a book.</intro>
</Book>
```

Below is an example of a type with both simple and compound members. It shows two levels of referencing.

Note that the “href” attribute of the Author accessor element is a reference to the value whose “id” attribute matches; a similar construction appears for the Address.

```
<Book>
    <title>My Life and Work</title>
    <author href=“#Person-1”/>
</Book>
<Person id=“Person-1”>
    <name>Henry Ford</name>
    <address href=“#Address-2”/>
</Person>
<Address id=“Address-2”>
      <email>henryford@hotmail.com</email>
    <web>www.henryford.com</web>
</Address>
```

The form above is appropriate when the Person value and the Address value are multi-reference. If these were instead both single-reference, they SHOULD be embedded, as follows:

```
<Book>
    <title>My Life and Work</title>
    <author>
        <name>Henry Ford</name>
        <address>
            <email>henryford@hotmail.com</email>
            <web>www.henryford.com</web>
        </address>
    </author>
</Book>
```

If instead there existed a restriction that no two persons can have the same address in a given instance and that an address can be either a Street-address or an Electronic-address, a Book with two authors would be encoded as follows:

```
<Book>
    <title>My Life and Work</title>
    <firstauthor href=“#Person-1”/>
    <secondauthor href=“#Person-2”/>
</Book>
<Person id=“Person-1”>
    <name>Henry Ford</name>
    <address xsi:type=“m:Electronic-address”>
        <email>henryford@hotmail.com</email>
        <web>www.henryford.com</web>
    </address>
</Person>
<Person id=“Person-2”>
    <name>Samuel Crowther</name>
    <address xsi:type=“n:Street-address”>
        <Street>Martin Luther King Rd</Street>
        <City>Raleigh</City>
        <State>North Carolina</State>
    </address>
</Person>
```

Generic Records

There are cases where a struct is represented with its members named and values typed at run time. Even in these cases, the existing rules apply. Each member is encoded as an element with matching name, and each value is either contained or referenced. Contained values MUST have an “xsi:type” attribute giving the type of the value.

Arrays

The representation of the value of an array is an ordered sequence of elements constituting items of the array. The element name for each element is the element type.

As with complex types generally, if the type of an item in the array is a single-reference type, each item contains its value. Otherwise, the item references its value via an href attribute.

The following example is an array containing integer array members. The length attribute is optional.

```
<SOAP-ENC:Array SOAP-ENC:arrayType=“u:int[2]”>
    <item>3</item>
    <item>4</item>
</SOAP-ENC:Array>
```

The following is an example of a two-dimensional array of strings.

```
<SOAP-ENC:Array SOAP-ENC:arrayType=“u:string[2,3]”>
    <string>r1c1</string>
    <string>r1c2</string>
    <string>r1c3</string>
    <string>r2c1</string>
    <string>r2c2</string>
    <string>r2c3</string>
</SOAP-ENC:Array>
```

The following is an example of an array of two arrays, each of which is an array of strings.

```
<SOAP-ENC:Array SOAP-ENC:arrayType=“SOAP-ENC:Array[2]”>
    <SOAP-ENC:Array href=“#array-1”/>
    <SOAP-ENC:Array href=“#array-2”/>
</SOAP-ENC:Array>
<SOAP-ENC:Array id=“array-1” SOAP-
ENC:arrayType=“u:string[3]”>
    <string>r1c1</string>
    <string>r1c2</string>
    <string>r1c3</string>
</SOAP-ENC:Array>
<SOAP-ENC:Array id=“array-2” SOAP-
ENC:arrayType=“u:string[2]”>
    <string>r2c1</string>
    <string>r2c2</string>
</SOAP-ENC:Array>
```

Finally, the following is an example of an array of phone numbers embedded in a struct of type Person and accessed through the accessor “phone-numbers”:

```
<Person>
<name>John Hancock</name>
    <phone-numbers SOAP-ENC:arrayType=“u:string[2]”>
        <string>111-2222</string>
        <string>999-0000</string>
    </phone-numbers>
</Person>
```

A multi-reference array is always encoded as an independent element whose element name is ” SOAP-ENC:Array”. For example an array of order structs encoded as an independent element:

```
<SOAP-ENC:Array SOAP-ENC:arrayType=“u:Order[2]”>
    <Order>
          <Product>Apple</Product>
        <Price>1.56</Price>
    </Order>
    <Order>
        <Product>Peach</Product>
        <Price>1.48</Price>
    </Order>
</SOAP-ENC:Array>
```

A single-reference array is encoded as an embedded element whose element name is the accessor name.

```
<PurchaseOrder>
    <CustomerName>Henry Ford</CustomerName>
    <ShipTo>
        <Street>5th Ave</Street>
        <City>New York</City>
        <State >NY</State>
        <Zip>10010</Zip>
    </ShipTo>
    <PurchaseLineItems SOAP-ENC:arrayType=”u:Order[2]”>
        <Order>
            <Product>Apple</Product>
            <Price>1.56</Price>
          </Order>
        <Order>
            <Product>Peach</Product>
            <Price>1.48</Price>
        </Order>
    </PurchaseLineItems>
</PurchaseOrder>
```

Note that it is explicitly legal per this specification to follow the style used for serializing arrays and yet not explicitly mark an element as being an array. See the PurchaseLineItems element in the example here:

```
<PurchaseOrder>
    <CustomerName>Henry Ford</CustomerName>
    <ShipTo>
        <Street>5th Ave</Street>
        <City>New York</City>
        <State>NY</State>
        <Zip>10010</Zip>
    </ShipTo>
    <PurchaseLineItems>
        <Order>
            <Product>Apple</Product>
            <Price>1.56</Price>
        </Order>
        <Order>
            <Product>Peach</Product>
            <Price>1.48</Price>
        </Order>
    </PurchaseLineItems>
</PurchaseOrder>
```

Partially Transmitted Arrays

SOAP provides support for partially transmitted arrays, known as “varying” arrays, in some contexts [12]. A partially transmitted array indicates in an “offset” attribute the zero-origin index of the first element transmitted; if omitted, the offset is taken as zero.

The following is an example of an array of size five that transmits only the third and fourth element:

```
<SOAP-ENC:Array SOAP-ENC:arrayType=“u:string[5]”
offset=“[2]”>
    <string>The third element</string>
    <string>The fourth element</string>
</Arrayofstring>
```

Sparse Arrays

SOAP provides support for sparse arrays in some contexts. Each element contains a “position” attribute that indicates its position within the array. The following is an example of array of arrays of strings:

```
<SOAP-ENC:Array SOAP-ENC:arrayType=“u:string[,] [2]”>
    <Arrayofstring href=“#array-1” position=“[2]”/>
</SOAP-ENC:Array>
<SOAP-ENC:Array id=“array-1” SOAP-
ENC:arrayType=“u:string[10,10]”>
    <string position=“[2,2] ”>The third element”</item>
    <string position=“[7,2] ”>The eighth element</item>
</SOAP-ENC:Array>
```

Assuming that the only reference to array-1 occurs in the enclosing array, this example could also have been encoded as follows:

```
<SOAP-ENC:Array xsi:type=“string[,] [2]”>
    <SOAP-ENC:Array position=“[2]”>
        <SOAP-ENC:Array xsi:type=“string[10,10]”>
            <string position=“ [2,2] ”>The third
element“</string>
            <string position=“ [7,2] ”>The eighth
element</string>
        </SOAP-ENC:Array>
    </SOAP-ENC:Array>
</SOAP-ENC:Array>
```

Default Values

An omitted accessor element implies either a default value or that no value is known. The specifics depend on the accessor, method, and its context. Typically, an omitted accessor implies a Null value for polymorphic accessors (with the exact meaning of Null accessor-dependent). Typically, an omitted Boolean accessor implies either a False value or that no value is known, and an omitted numeric accessor implies either that the value is zero or that no value is known.

SOAP Root Attribute

The SOAP root attribute can be used to label serialization roots that are not true roots of an object graph so that the object graph can be deserialized. The attribute can have one of two values, either “1” or “0”. True roots of an object graph have the implied attribute value of “1”. Serialization roots that are not true roots can be labeled as serialization roots with an attribute value of “1” An element can explicitly be labeled as not being a serialization root with a value of “0”.

The SOAP root attribute MAY appear on any subelement within the SOAP Header and SOAP Body elements. The attribute does not have a default value.

Using SOAP in HTTP

This section describes how to use SOAP within HTTP with or without using the HTTP Extension Framework. Binding SOAP to HTTP provides the advantage of being able to use the formalism and decentralized flexibility of SOAP with the rich feature set of HTTP. Carrying SOAP in HTTP does not mean that SOAP overrides existing semantics of HTTP but rather that the semantics of SOAP over HTTP maps naturally to HTTP semantics.

SOAP naturally follows the HTTP request/response message model providing SOAP request parameters in a HTTP request and SOAP response parameters in a HTTP response. Note, however, that SOAP intermediaries are NOT the same as HTTP intermediaries. That is, an HTTP intermediary addressed with the HTTP Connection header field cannot be expected to inspect or process the SOAP entity body carried in the HTTP request.

HTTP applications MUST use the media type “text/xml” when including SOAP entity bodies in HTTP messages.

SOAP HTTP Request

Although SOAP might be used in combination with a variety of HTTP request methods, this binding only defines SOAP within HTTP POST requests.

The SOAPAction HTTP Header Field

The SOAPAction HTTP request header field can be used to indicate the intent of the SOAP HTTP request. The value is a URI identifying the intent. SOAP places no restrictions on the format or specificity of the URI or that it is resolvable. An HTTP client MUST use this header field when issuing a SOAP HTTP Request.

soapaction = “SOAPAction” “:” [ <“> URI-reference <”> ]
URI-reference = <as defined in RFC 2396 [4]>

The presence and content of the SOAPAction header field can be used by servers such as firewalls to appropriately filter SOAP request messages in HTTP. The header field value of empty string (“”) means that the intent of the SOAP message is provided by the HTTP Request-URI. No value means that there is no indication of the intent of the message.

### EXAMPLES

SOAPAction: “http://electrocommerce.org/abc#MyMessage”
SOAPAction: “myapp.sdl”
SOAPAction: “ ”
SOAPAction:

SOAP HTTP Response

SOAP HTTP follows the semantics of the HTTP Status codes for communicating status information in HTTP. For example, a 2×× status code indicates that the client's request including the SOAP component was successfully received, understood, and accepted etc.

In case of a SOAP error while processing the request, the SOAP HTTP server MUST issue an HTTP 500 “Internal Server Error” response and include a SOAP message in the response containing a SOAP Fault element indicating the SOAP processing error.

The HTTP Extension Framework

A SOAP message MAY be used together with the HTTP Extension Framework [6 ] in order to identify the presence and intent of a SOAP HTTP request.

Whether to use the Extension Framework or plain HTTP is a question of policy and capability of the communicating parties. Clients can force the use of the HTTP Extension Framework by using a mandatory extension declaration and the “M-” HTTP method name prefix. Servers can force the use of the HTTP Extension Framework by using the 510 “Not Extended” HTTP status code. That is, using one extra round trip, either party can detect the policy of the other party and act accordingly.

The extension identifier used to identify SOAP using the Extension Framework is

http://schemas.xmlsoap.org/soap/envelope/

SOAP HTTP Examples

### EXAMPLE 3

### SOAP HTTP Using POST

POST /StockQuote HTTP/1.1
Content-Type: text/xml
Content-Length: nnnn
SOAPAction: “http://electrocommerce.org/abc#MyMessage”
<SOAP-ENV:Envelope
HTTP/1.1 200 OK
Content-Type: text/xml
Content-Length: nnnn
<SOAP-ENV:Envelope

### EXAMPLE 4

### SOAP Using HTTP Extension Framework

M-POST /StockQuote HTTP/1.1
Man: “http://schemas.xmlsoap.org/soap/envelope/”; ns=NNNN
Content-Type: text/xml
Content-Length: nnnn
NNNN-SOAPAction: “http://electrocommerce.org/abc#MyMessage”
<SOAP-ENV:Envelope
HTTP/1.1 200 OK
Ext:
Content-Type: text/xml
Content-Length: nnnn
<SOAP-ENV:Envelope

Using SOAP for RPC

One of the design goals of SOAP is to encapsulate and exchange RPC calls using the extensibility and flexibility of XML. In order to provide a uniform mechanism for representing a method call and response, SOAP defines a mapping to be used with the SOAP encoding. This mapping is implied whenever the SOAP encoding is used.

Using SOAP for RPC is orthogonal to the SOAP protocol binding. In the case of using HTTP as the protocol binding, an RPC call maps naturally to an HTTP request and an RPC response maps to an HTTP response. However, using

SOAP for RPC is not limited to the HTTP protocol binding.

To make a method call, the following information is needed:

The URI of the target object

A method name

An optional method signature

The parameters to the method

Optional header data

SOAP relies on the protocol binding to provide a mechanism for carrying the URI. For example, for HTTP the request URI indicates the resource that the invocation is being made against. Other than it be a valid URI, SOAP places no restriction on the form of an address (see [4] for more information on URIs).

RPC and SOAP Body

RPC method calls and responses are both carried in the SOAP Body element using the following encoding

The method name is the first immediate child element of the SOAP Body element

Method parameters ([in] and [in/out] for a request, [in/out] and [out] for a response) are each encoded as child elements of the method name element using the following rules:

The name of the parameter in the method signature is used as the name of the corresponding element.

Parameter values are expressed using the above rules.

RPC faults are expressed using the SOAP Fault element.

Processing of requests in the face of missing parameters is application defined.

Because a result indicates success and a fault indicates failure, it is an error for the method response to contain both a result and a fault.

RPC and SOAP Header

An example of the use of the header element is the passing of a transaction ID along with a message. Since the transaction ID is not part of the signature and is typically held in an infrastructure component rather than application code, there is no direct way to pass the necessary information with the call. By adding an entry to the headers and giving it a fixed name, the transaction manager on the receiving side can extract the transaction ID and use it without affecting the coding of remote procedure calls.

### References for this Appendix

[1] S. Bradner, “The Internet Standards Process—Revision 3”, RFC2026, Harvard University, October 1996

S. Bradner, “Key words for use in RFCs to Indicate Requirement Levels”, RFC 2119, Harvard University, March 1997

[3] D. Crocker, P. Overell, “Augmented BNF for Syntax Specifications: ABNF”, RFC 2234, Internet Mail Consortium, Demon Internet Ltd. November 1997

[4] T. Berners-Lee, R. Fielding, L. Masinter, “Uniform Resource Identifiers (URI): Generic Syntax”, RFC 2396, MIT/LCS, U. C. Irvine, Xerox Corporation, August 1998.

[5] R. Fielding, J. Gettys, J. C. Mogul, H. Frystyk, T. Berners-Lee, “Hypertext Transfer Protocol—HTTP/1.1”, RFC 2616, U. C. Irvine, DEC W3C/MIT, DEC, W3C/MIT, W3C/MIT, January 1997

[6] H. Nielsen, P. Leach, S. Lawrence, “An HTTP Extension Framework”, RFC 2774, Microsoft, Microsoft, Agranat Systems

[7] W3C Recommendation “The XML Specification”

[8] W3C Recommendation “Namespaces in XML”

[9] W3C Working Draft “XML Linking Language”. This is work in progress.

[10] W3C Working Draft “XML Schema Part 1: Structures”. This is work in progress.

[11] W3C Working Draft “XML Schema Part 2: Datatypes”. This is work in progress.

[12] Transfer Syntax NDR, in “DCE 1.1: Remote Procedure Call”

[13] N. Freed, N. Borenstein, “Multipurpose Internet Mail Extensions (MIME) Part One: Format of Internet Message Bodies”, RFC2045, Innosoft, First Virtual, November 1996

SOAP Envelope Examples

Sample Encoding of Call Requests

### EXAMPLE 5

### Similar to Example 1 but with a Mandatory Header

```
POST /StockQuote HTTP/1.1
Host: www.stockquoteserver.com
Content-Type: text/xml
Content-Length: nnnn
SOAPAction: “Some-URI”
<SOAP-ENV:Envelope
  xmlns:SOAP-
ENV=“http://schemas.xmlsoap.org/soap/envelope/”
  SOAP-
ENV:encodingStyle=“http://schemas.xmlsoap.org/soap/encoding/”/>
    <SOAP-ENV:Header>
        <t:Transaction
            xmlns:t=“some-URI”
            SOAP-ENV:mustUnderstand=“1”>
                5
        </t:Transaction>
    </SOAP-ENV:Header>
    <SOAP-ENV:Body>
        <m:GetLastTradePrice xmlns:m=“Some-URI”>
            <symbol>DEF</symbol>
        </m:GetLastTradePrice>
    </SOAP-ENV:Body>
</SOAP-ENV:Envelope>
```

### EXAMPLE 6

### Similar to Example 1 but with a Struct

```
POST /StockQuote HTTP/1.1
Host: www.stockquoteserver.com
Content-Type: text/xml
Content-Length: nnnn
SOAPAction: “Some-URI”
<SOAP-ENV:Envelope
  xmlns:SOAP-
ENV=“http://schemas.xmlsoap.org/soap/envelope/”
  SOAP-
ENV:encodingStyle=“http://schemas.xmlsoap.org/soap/encoding/”/>
    <SOAP-ENV:Body>
        <m:GetLastTradePriceDetailed
          xmlns:m=“Some-URI”>
              <Symbol>DEF</Symbol>
            <Company>DEF Corp</Company>
            <Price>34.1</Price>
        </m:GetLastTradePriceDetailed>
    </SOAP-ENV:Body>
</SOAP-ENV:Envelope>
```

Sample Encoding of Response

### EXAMPLE 7

### Similar to Example 2 but with a Mandatory Header

```
HTTP/1.1 200 OK
Content-Type: text/xml
Content-Length: nnnn
<SOAP-ENV:Envelope
  xmlns:SOAP-
ENV=“http://schemas.xmlsoap.org/soap/envelope/”
  SOAP-
ENV:encodingStyle=“http://schemas.xmlsoap.org/soap/encoding/”/>
    <SOAP-ENV:Header>
        <t:Transaction>
          xmlns:t=“some-URI”
          xsi:type=“int” mustUnderstand=“1”>
            5
        </t:Transaction>
    </SOAP-ENV:Header>
    <SOAP-ENV:Body>
        <m:GetLastTradePriceResponse
          xmlns:m=“Some-URI”>
            <Price>34.5</Price>
        </m:GetLastTradePriceResponse>
    </SOAP-ENV:Body>
</SOAP-ENV:Envelope>
```

### EXAMPLE 8

### Similar to Example 2 but with a Struct

```
HTTP/1.1 200 OK
Content-Type: text/xml
Content-Length: nnnn
<SOAP-ENV:Envelope
  xmlns:SOAP-
ENV=“http://schemas.xmlsoap.org/soap/envelope/”
  SOAP-
ENV:encodingStyle=“http://schemas.xmlsoap.org/soap/encoding/”/>
    <SOAP-ENV:Body>
        <m:GetLastTradePriceResponse
          xmlns:m=“Some-URI”>
            <PriceAndVolume>
                <LastTradePrice>
                        34.5
                </LastTradePrice>
                <DayVolume>
                        10000
                </DayVolume>
            </PriceAndVolume>
        </m:GetLastTradePriceResponse>
    </SOAP-ENV:Body>
</SOAP-ENV:Envelope>
```

### EXAMPLE 9

### Similar to Example 2 but Failing to honor Mandatory Header

```
HTTP/1.1 500 Internal Server Error
Content-Type: text/xml
Content-Length: nnnn
<SOAP-ENV:Envelope
  xmlns:SOAP-
ENV=“http://schemas.xmlsoap.org/soap/envelope/”>
    <SOAP-ENV:Body>
        <SOAP-ENV:Fault>
            <faultcode>MustUnderstand</faultcode>
            <faultstring>SOAP Must Understand
Error</faultstring>
        </SOAP-ENV:Fault>
    </SOAP-ENV:Body>
</SOAP-ENV:Envelope>
```

### EXAMPLE 10

### Similar to Example 2 but Failing to handle Body

```
HTTP/1.1 500 Internal Server Error
Content-Type: text/xml
Content-Length: nnnn
<SOAP-ENV:Envelope
  xmlns:SOAP-
ENV=“http://schemas.xmlsoap.org/soap/envelope/”>
    <SOAP-ENV:Body>
        <SOAP-ENV:Fault>
            <faultcode>Server</faultcode>
            <faultstring>Server Error</faultstring>
            <detail>
                <e:myfaultdetails xmlns:e=“Some-URI”>
                    <message>
                      My application didn't work
                    </message>
                    <errorcode>
                      1001
                    </errorcode>
                </e:myfaultdetails>
            </detail>
        </SOAP-ENV:Fault>
    </SOAP-ENV:Body>
</SOAP-ENV:Envelope>
```

1. A method of serializing an object, the method comprising:
storing a data structure of an object while preserving a hierarchical arrangement and relationship of parameters within the data structure;
storing data associated with each parameter while preserving associations of each parameter with the data;
storing references to one or more serialized objects.

2. A method as recited in claim 1, wherein one or more of the references is the object being serialized by the storing steps.

3. An apparatus comprising:
a processor;
a computer-readable memory having computer-executable instructions stored thereon that, when executed by the processor, performs the acts of serializing an object, the acts comprising:
storing a data structure of an object while preserving a hierarchical arrangement and relationship of parameters within the data structure;
storing data associated with each parameter while preserving associations of each parameter with the data;
storing references to one or more serialized objects.

4. One or more computer-readable storage media having computer-executable instructions that, when executed by a computer, performs a method of serializing an object, the method comprising:
storing a data structure of an object while preserving a hierarchical arrangement and relationship of parameters within the data structure;
storing data associated with each parameter while preserving associations of each parameter with the data;
storing references to one or more serialized objects.
